(19) United States
(12) Patent Application Publication
(10) Pub. No.: US 2009/0263631 A1
(43) Pub. Date: Oct. 22, 2009

(54) FILM FORMING COMPOSITION FOR NANOIMPRINTING AND METHOD FOR PATTERN FORMATION

(75) Inventors: Yoshinori Sakamoto, Kanagawa (JP); Naoki Yamashita, Kanagawa (JP); Kiyoshi Ishikawa, Kanagawa (JP)

Correspondence Address: KNOBBE MARTENS OLSON & BEAR LLP, 2040 MAIN STREET, FOURTEENTH FLOOR, IRVINE, CA, 92614, US

(73) Assignee: Tokyo Ohka Kogyo Co., Ltd., Kawaski-shi (JP)

(21) Appl. No.: 12/064,075

(22) PCT Filed: Aug. 28, 2006
(86) PCT No.: PCT/JP2006/316882

§ 371 Date: Feb. 18, 2008

(30) Foreign Application Priority Data
Sep. 9, 2005 (JP) 2005-262009

(51) Int. Cl. B32B 3/10; C08G 77/14; C08L 83/06; C08J 3/28; B32B 38/06

(52) U.S. Cl. 428/195.1; 528/10; 525/106; 522/148; 524/588; 156/220

(57) ABSTRACT

This invention provides a film forming composition for nanoimprinting, which has excellent resistance to etching with oxygen gas, can prevent the separation of a transfer pattern, can eliminate a problem of a holing time on a substrate, and is also excellent in transferability, and photosensitive resist, a nanostructure, a method for pattern formation using the same, and a program for realizing the method for pattern formation. The film forming composition for nanoimprinting comprises a polymeric silicon compound having the function of causing a photocuring reaction. Preferably, the polymeric silicon compound has a functional group cleavable as a result of response to electromagnetic waves and causes a curing reaction upon exposure to electromagnetic waves. More preferred are siloxane polymer compounds, silicon carbide polymer compounds, polysilane polymer compounds, and silazane polymer compounds, or any mixture thereof.

### TECHNICAL FIELD

The present invention relates to a film-forming composition for nanoimprinting and a method for pattern formation using the same. More particularly, the present invention relates to a film-forming composition and a photosensitive resist for nanoimprinting, which are provided with a function to cause photocuring reaction, as well as a nanostructure, a method for pattern formation using the same, and a program for realizing the method for pattern formation.

### BACKGROUND ART

A lithography technology is a core technology of semiconductor device processes, and the electric wiring is further miniaturized with higher integration of the recent semiconductor integrated circuits (IC). Especially, in a semiconductor integrated circuit (IC) as referred to as a very large scale integrated circuit (VLSI), integration degree of elements surpasses 10,000,000, therefore a fine pattern lithography technique is essential.

As the fine pattern lithography technique for realizing the VLSI, optical exposure lithography techniques with KrF lasers, ArF lasers, F2 lasers, X-rays, far-ultraviolet rays, and the like have conventionally been used. These optical exposure lithography techniques have enabled pattern formation on the order of several dozen nm.

However, since devices used for the optical exposure lithography techniques are expensive, initial cost for the exposure devices has been increased with the further miniaturization. Moreover, a mask for obtaining a high resolution at the same level as a light wavelength is necessary for the optical exposure lithography, and the mask having such a microshape has been expensive. Furthermore, since the demand for higher integration is limitless, further miniaturization is required.

Under such circumstances, nanoimprint lithography was proposed in 1995 by Chou et al. of Princeton University (see Patent Document 1) The nanoimprint lithography is a technique to transfer a pattern of a mold to a resist by pressing the mold, in which a predetermined circuit pattern has been formed, to a surface of a substrate on which the resist has been applied.

The nanoimprint lithography, which has been proposed first by Chou et al., is called “thermal cycle nanoimprint lithography,” because the following processes are taken. Polymethyl methacrylate (PMMA), which is a thermoplastic resin, is used for a resist; the resist is softened by heating before transforming the resist; subsequently a mold is pressed against the resist to transform the resist; and thereafter the resist is cooled and cured. The thermal cycle nanoimprint lithography has enabled transfer of not more than 10 nm which has been difficult to achieve by the conventional optical exposure lithography, and it has been demonstrated that its resolution is determined depending on precision of forming a mold. That is, as long as such a mold is available, it has become possible to form a microstructure on the order of nanometers more easily with a less expensive device than in the case of the optical exposure lithography.

However, the thermal cycle nanoimprint lithography has problems such as reduction of the throughput due to the time taken by heating-up and cooling of the resist, dimensional change and reduction of the precision of the transfer pattern due to the temperature difference, and reduction of the alignment due to the thermal expansion.

Thus, nanoimprint lithography has been proposed, in which a photocurable resin which can be cured with ultra-violet rays is used for the resist in substitution for the thermoplastic resin. In this process, a mold is pressed against a resist constituted with the photocurable resin, subsequently ultra-violet rays are irradiated to cure the resin, and thereafter the mold is separated thereby obtaining a pattern. This technique is referred to as “photo-nanoimprint lithography”, since light is used to cure the resist.

The photo-nanoimprint lithography makes it possible to obtain a pattern only by photoirradiation such as ultra-violet rays, and there is no need for heating and cooling, thereby solving the aforementioned problems of the thermal cycle nanoimprint lithography. In addition, the mold is formed with a transparent material such as quartz or sapphire which transmits light, thereby making it easier to perform alignment by means of the transmission through the mold.

Another nanoimprint lithography has been proposed, in which a highly viscous material such as spin-on-glass (SOG) is used for a resist (see Patent Document 2). In this process, a resist constituted with the highly viscous material is applied to a substrate, subsequently a mold is pressed against the substrate and separated therefrom, thereby obtaining a pattern. Since the highly viscous material is used, it is possible to maintain the shape of the resist without applying heat or light. Such a technique is referred to as “room-temperature nanoimprint lithography”, since a pattern is obtained at a room temperature.

By using the room-temperature nanoimprint lithography, the time for heating/cooling the resist and the time for photoirradiation for the photocuring are not necessary depending on the material to be used, thereby making it possible to achieve high throughput.

Patent Document 1: U.S. Pat. No. 5,772,905

Patent Document 2: Japanese Unexamined Patent Application Publication No. 2003-100609

### DISCLOSURE OF THE INVENTION

### Problems to be Solved by the Invention

Meanwhile, in the nanoimprint lithography in general, after a pattern shape is formed by a resist, a thin remaining film to be depressed portions of the resist is removed by dry etching. The thin remaining film of the resist is removed by etching, thereby exposing the surface of the substrate. Subsequently, further etching is performed to the exposed portions of the substrate with the resist being a mask, thereby forming a pattern on the substrate. After the pattern formation to the substrate is completed, the resist used as the mask is removed from the substrate surface by a dissolution process or the like, thereby finally obtaining a substrate on which a pattern is carved.

In such an etching process of a substrate, selectivity is necessary in order to enhance the etching ratio of the substrate to the resist as the mask. In other words, it is necessary that the resist as the mask has resistance to etching, thereby increasing the selectivity ratio.

Meanwhile, a resist material having ultra-violet-ray curability used for the photo-nanoimprint lithography is generally an organic resin such as an epoxy-based, urethane-based, or imide-based resin. As for such an organic resin, in the case of etching by use of an oxygen (O₂) gas, carbon contained in the resist reacts with oxygen contained in the etching gas to promote decomposition of the resist, thereby deteriorating resistance to etching and reducing selectivity ratio as a result. Because of this, a gas such as fluorine (F₂) is employed in many cases when etching the organic resin as a resist, in order to improve selectivity ratio. However this is not desirable in terms of the environmental problem.

Furthermore, in the photo-nancimprint lithography, an adhesive force between the mold and the photocurable resin is strong. Since this causes separation of the transfer pattern formed on the substrate, further improvement has been required.

On the other hand, in the room-temperature nanoimprint lithography in which the highly viscous material is used for a resist, further improvement has been required in terms of a holding time of the pattern shape transferred to the resist on the substrate, and the transferability of the pattern, which is formed on the mold, to the resist.

The present invention has been made in view of the aforementioned problems. An object of the present invention is to provide a film-forming composition for nanoimprinting, which has excellent resistance to etching with an oxygen gas, can prevent the separation of a transfer pattern, can eliminate a problem of a holding time on a substrate, and is also excellent in transferability. The present invention also provides photosensitive resist, a nanostructure, a method for pattern formation using the same, and a program for realizing the method for pattern formation.

### Means for Solving the Problems

The present inventors made every effort to study ways to solve the aforementioned problems, by paying attention to the necessity to reconcile the problems of both of the photo-nanoimprint lithography and the room-temperature nanoimprint lithography without impairing the advantages of the both lithography. As a result, the inventors have found that the aforementioned problems can be solved by using a polymeric silicon compound having a function to produce a photocuring reaction, and have completed the present invention. More specifically, the present invention provides the following.

(1) In a first aspect, there is provided a film-forming composition for nanoimprinting, the composition comprising a polymeric silicon compound having a function to produce a photocuring reaction.

Since the film-forming composition for nanoimprinting of the first aspect contains the polymeric silicon compound having the function to produce a photocuring reaction, it is possible to solve each of the problems while maintaining the advantages of the photo-nanoimprint lithography and the room-temperature nanoimprint lithography. That is, it is possible to achieve a resist pattern of a microstructure of not more than several nanometers, the resist pattern having resistance to etching with an oxygen gas which is compatible with the environmental problem, while maintaining high throughput in forming a resist pattern, without need of paying attention to the shape-holding time of thus obtained resist pattern.

(2) In a second aspect, there is provided the film-forming composition as recited in the first aspect, wherein the polymeric silicon compound has a functional group that is cleavable in response to electromagnetic waves, and produces a curing reaction by electromagnetic radiation.

Herein, the term “functional group that is cleavable in response to electromagnetic waves” refers to a functional group which is cleaved upon receiving electromagnetic radiation to be polymerizable. The film-forming composition of the second aspect has the functional group that is cleavable in response to electromagnetic waves, therefore has a function to produce a curing reaction by the polymerization of the functional group which has cleaved due to the electromagnetic radiation. This concept includes a group which can be cleaved to be polymerizable by radicals, acids, and alkalis, which are generated by other photosensitive substances (e.g., photopolymerization initiators, photoacid generators, photoalkali generators, and the like to be described later).

(3) In a third aspect, there is provided the film-forming composition as recited in the first or second aspect, wherein the polymeric silicon compound is at least one selected from a group consisting of a siloxane polymer compound, a silicon carbide polymer compound, a polysilane polymer compound, and a silazane polymer compound.

(4) In a forth aspect, there is provided the film-forming composition as recited in any one of the first to third aspects, wherein a weight-average molecular weight of the polymeric silicon compound is from 1,000 to 50,000.

As for the polymeric silicon compound, a film-forming ability can be improved with the weight-average molecular weight being not less than 1,000, while evenness can be improved with the weight-average molecular weight being not more than 50,000. Since the film-forming composition of the forth aspect, has a weight-average molecular weight of the polymeric silicon compound being from 1,000 to 50,000, it is possible to adequately perform the photocuring reaction necessary for the present invention. The weight-average molecular weight is more preferably from 1,000 to 10,000, and further preferably from 1,200 to 5,000.

(5) In a fifth aspect, there is provided the film-forming composition as recited in any one of the first to forth aspects, wherein the polymeric silicon compound is a condensation polymerization product of a compound including, as a starting material, at least one selected from alkoxysilanes represented by the following formula (A):

R¹ₙ—Si(OR²)₄₋ₙ (A)

wherein R¹ is a hydrogen atom, or an alkyl group or an aryl group having 1 to 20 carbon atoms; at least one of R¹ has a functional group that is cleavable in response to electromagnetic waves; R² is an alkyl group having 1 to 5 carbon atoms; and n represents an integer of 1 to 3.

The film-forming composition of the fifth aspect contains, as the polymeric silicon compound having the function to produce a photocuring reaction, a condensation polymerization product, in which at least one kind of predetermined alkoxysilanes is a starting material. The condensation polymerization product, in which an alkoxysilane is a starting material, is a siloxane polymer compound having siloxane bonds (Si—O bonds) in the main chain. Since the condensation polymerization product having the siloxane bonds has excellent adhesion properties to a substrate, it is possible to prevent separation of the resist pattern at the time of mold release. Furthermore, the condensation polymerization product having siloxane bonds has excellent resistance to etching with a gas other than the oxygen gas. This broadens a range of selection of an etching gas, thereby making it possible to form a pattern on a substrate independently of a particular kind of gas.

(6) In a sixth aspect, there is provided the film-forming composition as recited in any one of the second to fifth aspects, wherein the functional group that is cleavable in response to electromagnetic waves is at least one selected from a group consisting of an epoxy group, an acryl group, a methacryl group, and an oxetanyl group.

(7) In a seventh aspect, there is provided the film-forming composition as recited in any one of the second to sixth aspects, wherein the electromagnetic waves are ultra-violet rays, or light rays or corpuscular rays with a wavelength being shorter than the ultra-violet rays.

(8) In an eighth aspect, there is provided the film-forming composition as recited in any one of the second to seventh aspects, further comprising a hydrocarbon-based resin that is responsive to the electromagnetic waves.

The “hydrocarbon-based resin that is responsive to electromagnetic waves” is a resin having a function to produce a curing reaction upon receiving electromagnetic radiation: by polymerization of the hydrocarbon-based resin itself; or by copolymerization of the hydrocarbon-based resin and the polymeric silicon compound. Since the film-forming composition of the eighth aspect includes the hydrocarbon-based resin that is cured in response to the electromagnetic waves, the response to the electromagnetic waves becomes more sensitive, therefore the film-forming composition can be more easily cured. Moreover, it is possible to adjust the selectivity ratio of the obtained resist by compounding the organic resin.

(9) In a ninth aspect, there is provided the film-forming composition as recited in any one of the first to eighth aspects, further comprising a photopolymerization initiator.

The photopolymerization initiator has a function to cleave the “functional group that is cleavable in response to electromagnetic waves” and to promote the polymerization. Thus, since the film-forming composition of the ninth aspect includes the photopolymerization initiator, the response to the electromagnetic waves becomes more sensitive, therefore the film-forming composition can be more easily cured.

(10) In a tenth aspect, there is provided the film-forming composition as recited in any one of the first to ninth aspects, further comprising an acid generator and/or an alkali generator.

The acid generator and/or the alkali generator have/has a function to cleave the “functional group that is cleavable in response to electromagnetic waves” and to promote the polymerization. Thus, since the film-forming composition of the tenth aspect includes the acid generator and/or the alkali generator, the response to the electromagnetic waves becomes more sensitive, therefore the film-forming composition can be more easily cured.

Moreover, the acid generator and/or the alkali generator have/has a function as a catalyst to promote hydrolysis in the alkoxy group of the alkoxysilanes. The alkoxysilanes form a network of the siloxane bonds (Si—O bonds) by a sol-gel reaction. Therefore, in cases where the film-forming composition includes the alkoxysilane, hydrolysis of the alkoxysilane is promoted by the presence of the acid generator and/or the alkali generator. This makes it easy for a subsequent condensation polymerization reaction to proceed. As a result, it can be easy to perform a curing reaction of the film.

(11) In an eleventh aspect, there is provided the film-forming composition as recited in any one of the first to tenth aspects, further comprising a surfactant.

Since the film-forming composition of the eleventh aspect includes the surfactant, it is possible to improve application properties to the substrate. Since the surfactant exists, it is possible to improve spreading properties of the film-forming composition to the substrate, even in cases where the film-forming composition is highly viscous.

(12) In a twelfth aspect, there is provided a photosensitive resist for use in nanoimprint lithography, the photosensitive resist being obtained by curing the film-forming composition as recited in any one of the first to eleventh aspects.

According to the invention of the twelfth aspect, the photosensitive resist is cured by electromagnetic waves, therefore there is no need to pay attention to the shape-holding time of the resist pattern. Moreover, since the cured material of the polymeric silicon compound has excellent adhesion properties to the substrate, it is possible to avoid separation of the transfer pattern at the time of the mold release, thus to obtain a resist having a reduced level of defectiveness of the pattern. Furthermore, since the resist using the cured material of the polymeric silicon compound has high resistance not only to the oxygen gas but also to various kinds of etching gases, it is possible to perform the etching to the substrate without necessity to select a kind of etching gas.

(13) In a thirteenth aspect, there is provided a method for pattern formation by nanoimprint lithography, the method comprising: a lamination process in which the film-forming composition as recited in any one of the first to eleventh aspects is laminated to a substrate, thereby forming a film-forming composition layer; a transformation process in which a mold, on which a pattern of a relief structure is formed, is pressed against the film-forming composition layer on the substrate, thereby transforming the film-forming composition layer into the pattern of the relief structure; and a transfer process in which electromagnetic waves are irradiated to the film-forming composition layer to form a resist, in a state where the mold is in contact with the film-forming composition layer, thereby transferring the pattern of a relief structure to the resist.

(14) In a fourteenth aspect, there is provided the method for pattern formation as recited in the thirteenth aspect, wherein the transfer process is performed under reduced pressure or in a vacuum.

According to the method for pattern formation of the fourteenth aspect, since the transfer process is performed under reduced pressure or in a vacuum, air in the atmosphere is prevented from being incorporated at the time when the mold is brought into contact with the film-forming composition layer. This makes it possible to avoid defectiveness and deterioration of the resist pattern due to the air-bubble inclusion.

(15) In a fifteenth aspect, there is provided the method for pattern formation as recited in the thirteenth or fourteenth aspect, further comprising a baking process of baking the resist on which the pattern of the relief structure has been transferred.

The method for pattern formation of the fifteenth aspect has a process of baking the transferred resist, thereby making it possible to assist curing the resist formed from the film-forming composition.

(16) In a sixteenth aspect, there is provided the method for pattern formation as recited in any one of the thirteenth to fifteenth aspects, further comprising, after the transfer process: a release process in which the mold is released from the resist; and an etching process in which at least a portion of the resist is removed by irradiation of a plasma and/or reactive ion.

According to the method for pattern formation of the sixteenth aspect, a plasma and/or reactive ion is irradiated to the resist on the substrate after releasing the mold, thereby removing at least a portion of the resist by etching.

Herein, the term “at least a portion of the resist” means that a thin film at depressed portions of the resist (i.e., portions formed by being touched by protruding portions of the mold) is removed by dry etching by means of the plasma and/or reactive ion, thereby exposing the surface of the substrate.

(17) In a seventeenth aspect, there is provided the method for pattern formation as recited in the sixteenth aspect, wherein, in the etching process, the etching is performed to the substrate simultaneously or sequentially with at least a portion of the resist.

(18) In an eighteenth aspect, there is provided a nanostructure obtained by the method for pattern formation as recited in any of the thirteenth to seventeenth aspects.

The nanostructure of the eighteenth aspect can serve as a structure having microstructures of not more than several nanometers, depending upon precision of the mold to be used. Because of this, it is possible to preferably use the nanostructure of the eighteenth aspect in the field requiring a hyperfine structure.

(19) In a nineteenth aspect, there is provided the nanostructure as recited in the eighteenth aspect, wherein the nanostructure is any one of a semiconductor device, a wiring substrate, an optical element, and an analysis device.

(20) In a twentieth aspect, there is provided a program for allowing a computer to execute pattern formation by nanoimprint lithography, the pattern formation comprising: a compression step in which a mold, on which a pattern of a relief structure has been formed, is pressed against a film-forming composition layer formed by laminating the film-forming composition as recited in any one of the first to eleventh aspects on a substrate, so as to compress the film-forming composition layer to give a desired shape; a transfer step in which electromagnetic waves are irradiated to the film-forming composition layer to form a resist, in a state where the mold is in contact with the film-forming composition layer, thereby transferring the pattern of the relief structure to the resist; and a release step in which the mold is released from the resist, wherein the compression step further comprises a step of controlling a load, and wherein the transfer step further comprises a step of controlling a load, a temperature, and time.

The program of the twentieth aspect controls a load in the compression step, as well as a load, a temperature, and time in the transfer step. Therefore, by executing the program of the twentieth aspect, it is possible to control the compression step and the transfer step in advance and to automate the desired pattern formation, by means of conditions such as the substrate, the film-forming composition to be used, and a micropattern to be a target. Note that the term “computer” as described herein refers not only to a control section to transmit control signals (e.g., CPU), but also to an entire device to perform pattern formation by the nanoimprint lithography. In other words, the program of the twentieth aspect allows a device for performing the pattern formation by the nanoimprint lithography to execute predetermined steps.

### Effects of the Invention

According to the film-forming composition for the nanoimprinting of the present invention, it is possible to realize the nanoimprint lithography, while exerting the advantages of both of the photo-nanoimprint lithography and the room-temperature nanoimprint lithography, as well as eliminating the problems of both of them. That is, according to the film-forming composition of the present invention, it is possible to obtain a resist, which has excellent resistance to etching with an oxygen gas, prevents separation of the transfer pattern, eliminates the problem about the holding time on the substrate, and has excellent transferability. Furthermore, the resist formed with the film-forming composition of the present invention has excellent resistance to etching with gases other than the oxygen gas. This broadens a range of selection of an etching gas, thereby making it possible to form a pattern on a substrate independently of a particular kind of gas.

### BRIEF DESCRIPTION OF THE DRAWINGS

FIGS. 1A to 1F show processes of nanoimprint lithography.

### EXPLANATION OF REFERENCE NUMERALS

1, substrate

2, film-forming composition

3, mold

4, thin film of cured material of film-forming composition

### PREFERRED MODE FOR CARRYING OUT THE INVENTION

Herein below, a method for pattern formation by nanoimprint lithography as an embodiment of the present invention is described with reference to the drawings. Although an example is given here in which a structure formed from the composition of the present invention is used as a resist, the present invention is not limited thereto, but the formed structure as it is, or following adjusting its shape by etching or the like can be used for other purposes.

### Pattern Formation by Nanoimprint Lithography

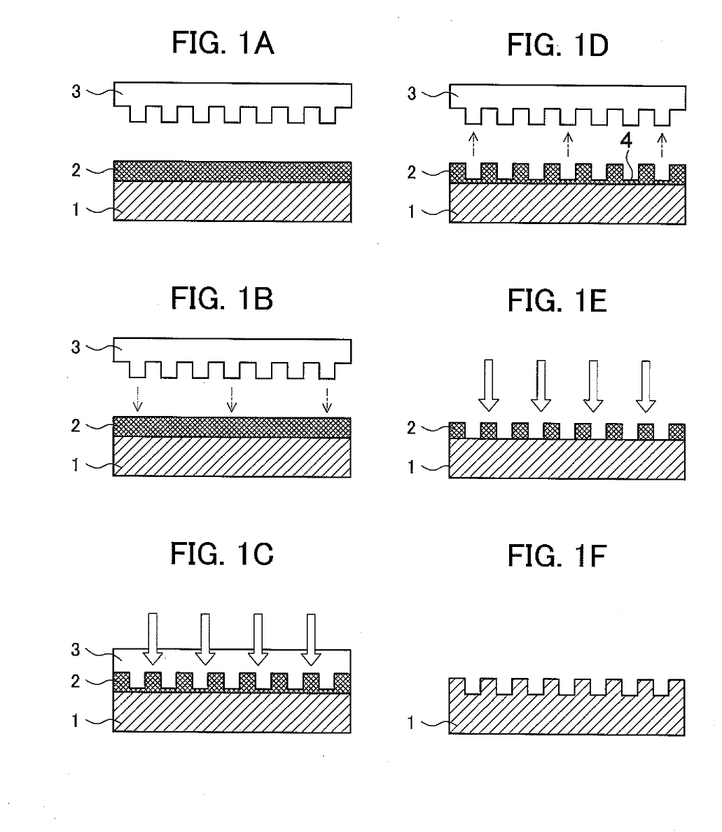

FIGS. 1A to 1F show processes of nanoimprint lithography as an embodiment of the present invention. In this embodiment, there are a lamination process (FIG. 1A), a transformation process (FIG. 1B), a transfer process (FIG. 1C), a release process (FIG. 1D), an etching process (FIG. 1E), and a resist removal process (FIG. 1F). Each process is hereinafter explained.

### [Lamination Process]

FIG. 1A is a diagram which shows a lamination process. The lamination process is a process in which a film-forming composition of the present invention is laminated on a substrate 1, thereby forming a film-forming composition layer 2.

It is preferable that the film-forming composition of the present invention used in this embodiment be generally a highly viscous composition. Moreover, since the resist functions as a mask in a process of etching the substrate performed afterwards, it is preferable that a distance from the substrate be even by making the thickness even. Because of this, when the film-forming composition is laminated on the substrate 1, spin-coating is usually performed. Even if the film-forming composition is highly viscous, it is possible to evenly laminate by the spin-coating with a spinner.

### [Transformation Process]

FIG. 1B is a diagram which shows a transformation process. The transformation process is a process, in which: a mold 3, on which a pattern of a relief structure has been formed, is pressed against the film-forming composition layer 2 on the substrate 1, which has the film-forming composition laminated thereon in the lamination process; whereby the film-forming composition layer 2 is transformed into the pattern of the relief structure.

In the transformation process of this embodiment, the mold 3 is pressed against the film-forming composition layer 2 in a similar way usually performed in the nanoimprint lithography. Since the pattern of the relief structure has been formed on the mold 3, the film-forming composition layer 2 is transformed into the shape of the mold 3.

In the transformation process, it is preferable that the film-forming composition be filled in every corner of the depressed portions of the mold 3 (i.e., the protruding portions of the resist), in order to improve precision of the etching process to be performed later. Moreover, it is preferable that the film thickness of the resist be thin at the depressed portions of the resist (i.e., the portions to be in contact with the protruding portions of the mold 3) in the etching process to be performed later. Therefore, it is preferable that a pressing load of the mold 3 be controlled in the transformation process.

### [Transfer Process]

FIG. 1C is a diagram which shows a transfer process. The transfer process is a process, in which electromagnetic waves (illustrated by arrows) are irradiated to the film-forming composition layer 2, in a state where the mold 3 is in contact with the film-forming composition layer 2, thereby transferring the pattern of the relief structure of the mold 3 to the resist.

In the transfer process, the pattern of the relief structure of the mold 3 is transferred to the resist formed of the film-forming composition, by using a function of the film-forming composition of the present invention to produce a photocuring reaction. It is possible to produce the photocuring reaction by irradiating electromagnetic waves.

Moreover, it is preferable that the transfer process be performed under reduced pressure or in a vacuum. Since the transfer process is performed under reduced pressure or in a vacuum, it is possible to prevent air in the atmosphere from being incorporated at the time when the mold is brought into contact with the film-forming composition layer, and to avoid defectiveness and deterioration of the resist pattern due to the air-bubble inclusion.

In the transfer process, it is preferable that a load, a temperature, and time be controlled, since these factors affect the precision of the resist to be obtained. Specifically, a pressing load of the mold, a temperature of the substrate, time of the electromagnetic radiation, and the like are controlled.

### [Baking Process]

A baking process is a process, in which the resist, to which the pattern of the mold 3 has been transferred in the transfer process, is baked by heating. By further performing this process, it is possible to assist curing of the film-forming composition.

For example, in cases where the film-forming composition includes a condensate of alkoxysilane, the resist vitrifies through the baking process. Note that since the baking process in the present invention is a process of assisting the transfer process in which the electromagnetic radiation is performed, the baking process may be a process of heating for a short time.

### [Release Process]

FIG. 1D is a diagram which shows a release process. The release process is a process, in which the mold 3 is separated from the resist (film 2) after the transfer process. The release process makes it possible to obtain the substrate 1 on which a resist pattern is formed.

### [Etching Process]

FIG. 1E is a diagram which shows an etching process. The etching process is a process, in which a plasma and/or reactive ion (illustrated by arrows) is irradiated to the substrate 1 from which the mold 3 has been separated in the release process, thereby removing at least a portion of the resist (cured material of the film-forming composition) by etching.

In the etching process, at least a thin film 4 at the depressed portions (i.e., the portions formed by being in contact with the protruding portions of the mold 3) of the resist is removed. By removing the thin film 4 by etching, the surface of the substrate 1 is exposed. Moreover, the etching process of the substrate 1 may be performed simultaneously or sequentially.

The plasma and/or reactive ion gas used in etching process is not particularly limited as long as it is a gas which is usually used in the dry etching field. It is possible to select a preferable gas as appropriate by the selectivity ratio of the substrate and the resist.

Particularly, the cured material of the composition which includes the polymeric silicon compound, the cured material being the resist of the present invention, has high resistance to etching with various gases. This broadens a range of selection of a gas, thereby making it possible to select an etching gas depending upon the kind of the substrate to be used. For example, etching with an oxygen gas can be employed in a case of a Si—C based substrate, and etching with a fluorine gas can be employed in a case of a Si—O based substrate.

### [Resist Removal Process]

FIG. 1F is a diagram which shows a resist removal process. The resist removal process is a process, in which the resist (cured material of the film-forming composition) existing on the substrate is removed after completing the etching of the substrate 1.

The resist removal process is not particularly limited, as long as the process performs a treatment to remove the resist (cured material of the film-forming composition), which is not necessary any more, from the substrate 1. Examples of such a treatment include a treatment to wash the substrate by using a solution which is capable of dissolving the resist (cured material of the film-forming composition).

### Film-Forming Composition

The film-forming composition for nanoimprinting of the present invention will be hereinafter explained. The film-forming composition of the present invention is a composition, which has a function to produce a photocuring reaction, and which includes a polymeric silicon compound having a function to produce a photocuring reaction.

[Polymeric Silicon Compound having Function to Produce Photocuring Reaction]

In the film-forming composition of the present invention, it is preferable that the polymeric silicon compound having a function to produce a photocuring reaction has a functional group which is cleavable in response to electromagnetic waves, and is a polymeric silicon compound which produces a curing reaction by electromagnetic radiation. The electromagnetic waves referred to herein are preferably ultra-violet rays (UV light) in terms of ease of use.

The functional group, which is cleavable in response to electromagnetic waves, is not particularly limited, but includes, for example, an epoxy group, an acryl group, a methacryl group, an oxetanyl group, and the like. Only one kind or plural kinds of these functional groups may be included. The functional group is bonded to the polymeric silicon compound with an alkyl group or an aryl group having 1 to 20 carbon atoms which may be interrupted by an ester bond, an ether bond, or an amide bond. Particularly, it is preferable that the functional group be bonded to an Si atom in the polymeric silicon compound.

The number of the functional groups, which are cleavable in response to electromagnetic waves and which are included in one molecule of the polymeric silicon compound, is preferably from 1 to 3, and more preferably from 1 to 2. When the number of the functional groups, which are cleavable in response to electromagnetic waves, is less than one, it is impossible to provide a photocuring reaction to the film-forming composition of the present invention. In contrast, the number of the functional groups of more than three may not be preferable because of decrease of the siloxane bonds.

The polymeric silicon compound is not particularly limited, but in the present invention, it is at least one selected from a group consisting of a siloxane polymer compound having a Si—O bond in a main chain, a silicon carbide polymer compound having a Si—C bond in a main chain, a polysilane polymer compound having a Si—Si bond in a main chain, and a silazane polymer compound having a Si—N bond in a main chain. Moreover, any mixture of these can be used. It is possible to select compounds as appropriate, in order to increase the selectivity ratio with the substrate to be used.

The weight-average molecular weight of the polymeric silicon compound having a function to produce a photocuring reaction, which is used in the present invention, is preferably in a range of 1,000 to 50,000. It is possible to improve film-forming performance by having the weight-average molecular weight of not less than 1,000, while it is possible to improve evenness by having the weight-average molecular weight of not more than 50,000. Furthermore, the weight-average molecular weight in a range of 1,000 to 50,000 makes it possible to provide an appropriate photocuring reaction which is necessary for the present invention, and to provide sufficient strength to the film. The weight-average molecular weight is more preferably in a range of 1,000 to 10,000, and further preferably in a range of 1,200 to 5,000.

### Siloxane Polymer Compound

It is preferable that the siloxane polymer compound as the polymeric silicon compound having a function to produce a photocuring reaction in the film-forming composition of the present invention be a condensation polymerization product in which at least one kind of alkoxysilanes represented by the following formula (A) is a starting material.

R¹ₙ—Si(OR²)₄₋ₙ (A)

wherein, R¹ is a hydrogen atom, or an alkyl group or an aryl group having 1 to 20 carbon atoms; at least one of R¹ has a functional group that is cleavable in response to electromagnetic waves; R² is an alkyl group having 1 to 5 carbon atoms; and n represents an integer of 1 to 3.

The functional groups which are cleavable in response to electromagnetic waves in the aforementioned R¹ include, for example, a functional group having an ethylenic double bond such as an acryl group and a methacryl group, and a functional group having an epoxy group or an oxetanyl group. This R¹ may be interrupted by an ether bond, an ester bond, or an amide bond.

Specific examples of the compounds represented by the above formula (A) are as follows.

(a1) In the case of n=1, examples include monoacryloxypropyltrimethoxysilane, monomethacryloxypropyltrimethoxysilane, monoglycidyloxypropyltrimethoxysilane, monovinyltrimethoxysilane, monoacryloxypropyltriethoxysilane, monomethacryloxypropyltriethoxysilane, monoglycidyloxypropyltriethoxysilane, monovinyltriethoxysilane, monoacryloxypropyltripropoxysilane, monomethacryloxypropyltripropoxysilane, monoglycidyloxypropyltripropoxysilane, monovinyltripropoxysilane, monoacryloxypropyltributoxysilane, monomethacryloxypropyltributoxysilane, monoglycidyloxypropyltributoxysilane, and monovinyltributoxysilane.

(a2) In the case of n=2, examples include diacryloxypropyldimethoxysilane, dimethacryloxypropyldimethoxysilane, diglycidyloxypropyldimethoxysilane, divinyldimethoxysilane, diacryloxypropyldipropoxysilane, dimethacryloxypropyldipropoxysilane, diglycidyloxyprcpyldipropoxysilane, divinyldipropcxysilane, diacryloxypropyldibutoxysilane, dimethacryloxypropyldibutoxysilane, diglycidyloxypropyldibutoxysilane, and divinyldibutoxysilane.

(a3) In the case of n=3, examples include triacryloxypropylmonomethoxysilane, trimethacryloxypropylmonomethoxysilane, triglycidyloxypropylmonomethoxysilane, trivinylmonomethoxysilane, diacryloxypropyldiethoxysilane, dimethacryloxypropyldiethoxysilane, diglycidyloxypropyldiethoxysilane, divinyldiethoxysilane, triacryloxypropylmonoethoxysilane, trimethacryloxyprcpyltrimonoethoxysilane, triglycidyloxypropylmonoethoxysilane, trivinylmonoethoxysilane, triacryloxypropylmonopropoxysilane, trimethacryloxypropylmonopropoxysilane, triglycidyloxypropylmonopropoxysilane, trivinylmonopropoxysilane, triacryloxypropylmonobutoxysilane, trimethacryloxypropylmonobutoxysilane, triglycidyloxypropylmonobutoxysilane, and trivinylmonobutoxysilane.

Also, a hydrolysis condensate of the aforementioned compound (A) and alkoxysilane other than the aforementioned compound (A) is illustrated as a preferable siloxane polymer compound.

Alkoxysilanes other than the aforementioned compound (A) include alkoxysilanes represented by the following formula (B).

R³ₘ—Si(OR⁴)₄₋ₘ (B)

wherein, R³ is a hydrogen atom, or an alkyl group or an aryl group having 1 to 20 carbon atoms; R⁴ is an alkyl group having 1 to 5 carbon atoms; and m represents an integer of 0 to 3.

Specific examples of the compounds represented by the general formula (B) are as follows.

(b1) In the case of m=0, examples include tetramethoxysilane, tetraethoxysilane, tetrapropoxysilane, and tetrabutoxysilane.

(b2) In the case of m=1, examples include monoalkyltrialkoxysilane such as monomethyltrimethoxysilane, monomethyltriethoxysilane, monomethyltripropoxysilane, monoethyltrimethoxysilane, monoethyltriethoxysilane, monoethyltripropcxysilane, monopropyltrimethoxysilane and monopropyltriethoxysilane, and monophenyltrialkoxysilane such as monophenyltrimethoxysilane and monophenyltriethoxysilane.

(b3) In the case of m=2, examples include dialkyldialkoxysilane such as dimethyldimethoxysilane, dimethyldiethoxysilane, dimethyldipropoxysilane, diethyldimethoxysilane, diethyldiethoxysilane, diethyldipropoxysilane, dipropyldimethoxysilane, dipropyldiethoxysilane and dipropylpropoxysilane, and diphenyldialkoxysilane such as diphenyldimethoxysilane and diphenyldiethoxysilane.

(b4) In the case of m=3, examples include trialkylalkoxysilane such as trimethylmethoxysilane, trimethylethoxysilane, trimethylpropoxysilane, triethylmethoxysilane, triethylethoxysilane, triethylpropoxysilane, tripropylmethoxysilane and tripropylethoxysilane, and triphenylalkoxysilane such as triphenylmethoxysilane and triphenylethoxysilane.

As for alkoxysilane represented by the above general formula (A) and/or (B), alkoxy group is hydrolyzed to a hydroxy group, and alcohol is generated. Thereafter, two molecules of the alcohol condense, thereby forming a network of Si—O—Si. This results in a siloxane polymer compound having a siloxane bond (Si—O bond) in a main chain.

The condensation polymerization of the alkoxysilane represented by the formula (A) and/or (B) is carried out by allowing the alkoxysilane to be a polymerizable monomer to react in the presence of an acid catalyst in an organic solvent. The alkoxysilanes represented by the formula (A) and/or (B) to be a polymerizable monomer may be subjected alone, or in combination of multiple kinds to the condensation polymerization.

The degree of hydrolysis of alkoxysilane, which is a prerequisite of the condensation polymerization, can be adjusted by the quantity of water to be added. Generally, water at the proportion of 1.0 to 10.0 times mol, preferably 1.5 to 8.0 times mol, is added to the total mol of alkoxysilane represented by the above formula (A) and/or (B). When the quantity of water to be added is not less than 1.0 times mol, it is possible to increase the hydrolysis degree and to facilitate the film-formation. On the other hand, it is possible to improve storage stability by suppressing gelation when the quantity of water is not more than 10.0 times mol.

Moreover, the acid catalyst used in condensation polymerization of alkoxysilane represented by the formula (A) and/or (B) is not particularly limited, but any of conventionally used organic or inorganic acid can be used. The organic acid includes organic carboxylic acids such as acetic acid, propionic acid and butyric acid. The inorganic acid includes hydrochloric acid, nitric acid, sulfuric acid and phosphoric acid. The acid catalyst may be directly added to a mixture of alkoxysilane and water, or may be added as an acidic aqueous solution with water to be added to alkoxysilane.

The hydrolysis reaction is usually completed in about 5 to 100 hours. Moreover, it is also possible to complete the reaction in a short reaction time, by adding an aqueous acid catalyst solution dropwise to an organic solvent including one or more kinds of alkoxysilanes represented by the formula (A) and/or (B) to permit the reaction at a temperature of from the room temperature to a heating temperature not exceeding 80° C. The hydrolyzed alkoxysilane causes a condensation reaction thereafter, to form a network of Si—O—Si as a result.

In cases where alkoxysilane of the formula (A) and alkoxysilane of the formula (B) are mixed, alkoxysilane of the formula (B) may be mixed in a range to provide photocurable characteristics, but it is preferable that alkoxysilane of the formula (A) be not less than 10 mol %.

### Electromagnetic Waves

The electromagnetic waves used in the present invention are not particularly limited, as long as they act on the functional group which is cleavable in response to the electromagnetic waves, thereby curing the film-forming composition. Examples include light rays such as ultra-violet rays or far-ultraviolet rays having a wavelength smaller than that of visible light, radioactive rays such as X-rays or gamma rays, and corpuscle beams such as electron beams. Among these, ultra-violet rays can be preferably used.

### [Other Component]

### Hydrocarbon-based Compound Which is Responsive to Electromagnetic Waves

It is preferable to include, as an arbitrary component, a hydrocarbon-based compound that is responsive to electromagnetic waves, into the film-forming composition of the present invention. The hydrocarbon-based compound, which is cured in response to electromagnetic waves, is a compound having a function by which the hydrocarbon-based compound itself polymerizes, or copolymerizes with the polymeric silicon compound upon receiving electromagnetic radiation, thereby producing a curing reaction. In the present invention, the hydrocarbon-based compound is not particularly limited as long as it has such a function, and a well known compound can be used as the hydrocarbon-based compound. The function of the hydrocarbon-based compound to respond to electromagnetic waves can be obtained, for example, by introducing a functional group, which is cleavable in response to electromagnetic waves, to the hydrocarbon-based compound.

Examples of this hydrocarbon-based compound include a compound having an ethylenic unsaturated double bond, an epoxy group, or an oxetanyl group. Such a compound having an ethylenic unsaturated double bond is a compound which has at least one ethylenic unsaturated double bond that cures by addition polymerization, and is a monomer having the ethylenic unsaturated double bond, or a polymer having the ethylenic unsaturated double bond in a side chain or a main chain. Note that the monomer falls in a concept for discriminating it from high polymeric substances, generally referred to, and is not limited to a “monomer” in a narrow sense, but includes dimer, trimer, and oligomer.

Examples of the monomer include unsaturated carboxylic acid, esters of an aliphatic (poly)hydroxy compound with an unsaturated carboxylic acid, esters of an aromatic (poly)hydroxy compound with an unsaturated carboxylic acid, esters obtained by an esterification reaction of unsaturated carboxylic acid with polyvalent carboxylic acid and a polyvalent hydroxy compound such as the aforementioned aliphatic (poly)hydroxy compound, or an aromatic (poly)hydroxy compound, unsaturated carboxylic acid amides, and unsaturated carboxylic acid nitrites.

Specifically, examples include methyl acrylate, methyl methacrylate, ethyl acrylate, ethyl methacrylate, isobutyl acrylate, isobutyl methacrylate, 2-hydroxyethyl acrylate, 2-hydroxyethyl methacrylate, ethylene glycol monomethyl ether acrylate, ethylene glycol monomethyl ether methacrylate, ethylene glycol monoethyl ether acrylate, ethylene glycol monoethyl ether methacrylate, glycerol acrylate, glycerol methacrylate, acrylic acid amide, methacrylic acid amide, acrylonitrile, methacrylonitrile, 2-ethylhexyl acrylate, 2-ethylhexyl methacrylate, benzyl acrylate, benzyl methacrylate, ethylene glycol diacrylate, diethylene glycol diacrylate, ethylene glycol dimethacrylate, triethylene glycol diacrylate, triethylene glycol dimethacrylate, tetraethylene glycol diacrylate, tetraethylene glycol dimethacrylate, butylene glycol dimethacrylate, propylene glycol diacrylate, propylene glycol dimethacrylate, trimethylolethane triacrylate, trimethylolethane trimethacrylate, trimethylolpropane triacrylate, trimethylolpropane trimethacrylate, tetramethylolpropane tetraacrylate, tetramethylolpropane tetramethacrylate, pentaerythritol triacrylate, pentaerythritol trimethacrylate, pentaerythritol tetraacrylate, pentaerythritol tetramethacrylate, dipentaerythritol pentaacrylate, dipentaerythritol pentamethacrylate, dipentaerythritol hexaacrylate, dipentaerythritol hexamethacrylate, 1,6-hexanediol diacrylate, 1,6-hexanediol dimethacrylate, cardo epoxy diacrylate, cardo epoxy dimethacrylate, these example compounds in which acrylate and methacrylate are replaced with fumarate, maleate, crotonate, or itaconate, as well as acrylic acid, methacrylic acid, fumaric acid, maleic acid, crotonic acid, itaconic acid, hydroquinone monoacrylate, hydroquinone monomethacrylate, hydroquinone diacrylate, hydroquinone dimethacrylate, resorcin diacrylate, resorcin dimethacrylate, pyrogallol diacrylate, pyrogallol triacrylate, condensates of acrylic acid with phthalic acid and diethylene glycol, condensates of acrylic acid with maleic acid and diethylene glycol, condensates of methacrylic acid with terephthalic acid and pentaerythritol, condensates of acrylic acid with adipic acid and butanediol, and with glycerine, ethylene bisacrylamide, ethylene bismethacrylamide, allylic esters of diallyl phthalate, and divinyl phthalate.

Moreover, examples of the polymer having an ethylenic unsaturated double bond in a side chain or a main chain include polyesters obtained by a polycondensation reaction of unsaturated bivalent carboxylic acid with a dihydroxy compound, polyamides obtained by a polycondensation reaction of unsaturated bivalent carboxylic acid with diamine, polyesters obtained by a polycondensation reaction of itaconic acid, propylidene succinic acid, ethylidene malonic acid with a dihydroxy compound, polyamides obtained by polycondensation reaction of itaconic acid, propylidene succinic acid, ethylidene malonic acid with diamine, phenol novolak-type epoxy acrylate, phenol novolak-type epoxy methacrylate, cresol novolak-type epoxy acrylate, cresol novolak-type epoxy methacrylate, bisphenol A-type epoxy acrylate, bisphenol S-type epoxy acrylate, urethane acrylate oligomers, urethane methacrylate cligomers, and the like. A product obtained by further allowing the epoxy (meth)acrylate resin to react with a polybasic acid anhydride may be used. Moreover, polymers having a functional group such as a hydroxy group or a halogenated alkyl group which has reaction activity in a side chain, for example, polymers obtained by a polymerizing reaction of polyvinyl alcohol, poly (2-hydroxy ethyl methacrylate), polyepichlorohydrin or the like with unsaturated carboxylic such as acrylic acid, methacrylic acid, fumaric acid, maleic acid, crotonic acid or itaconic acid, can be used. Above all, a monomer of acrylate ester or methacrylate ester can be preferably used in particular.

A single kind or a combination of more than one kind of these hydrocarbon-based compounds may be used.

The quantity of this hydrocarbon-based compound is not particularly limited, but it is preferable that 1 to 50 parts by weight of this hydrocarbon-based compound be included based on 100 parts by weight of the polymeric silicon compound, and it is more preferable that 10 to 30 parts by weight of this hydrocarbon-based compound be included based on 100 parts by weight of the polymeric silicon compound. It is possible to improve the photocurable characteristics by including the hydrocarbon-based compound of the quantity of not less than the aforementioned lower limits. Moreover, it is possible to suppress lowering of the resistance to fluorine gas by including the hydrocarbon-based compound of the quantity of not more than the aforementioned upper limits.

### Photopolymerization Initiator

Photopolymerization initiator is not particularly limited, but can be selected appropriately depending on the kind of resin or functional groups included in the film-forming composition. Necessary photopolymerization initiator, such as a photo-cation initiator, a photo-radical initiator and a photo-anion initiator, may be selected in accordance with the situation of the film-forming composition.

Examples of the photopolymerization initiator include 2,2-bis(2-chlorophenyl)-4,5,4′,5′-tetraphenyl-1,2′-biimidazole (hereinafter referred to as B-CIM, produced by Hodogaya Chemical Co., LTD.), 1-hydroxycyclohexylphenyl ketone, 2,2-dimethoxy-1,2-diphenylethan-1-one, 2-methyl-1-[4-(methylthio)phenyl]-2-morpholinopropan-1-one, 2-benzyl-2-dimethylamino-1-(4-morpholinophenyl)-butan-1-one, 2-hydroxy-2-methyl-1-phenylpropan-1-one, 2,4,6-trimethylbenzoyldiphenylphosphine oxide, 1-[4-(2-hydroxyethoxy)phenyl]-2-hydroxy-2-methyl-1-propan-1-one, 2,4-diethylthioxanthone, 2,4-dimethylthioxanthone, 3,3-dimethyl-4-methoxybenzophenone, benzophenone, 2-chlorobenzophenone, 4,4′-bisdimethylaminobenzophenone (hereinafter referred to as Michler's ketone), 4,4′-bisdiethylaminobenzophenone (hereinafter referred to as EAB-F, produced by Hodogaya Chemical Co., LTD.), 1-(4-isopropylphenyl)-2-hydroxy-2-methylpropan-1-one, 1-(4-dodecylphenyl)-2-hydroxy-2-methylpropan-1-one, 4-benzoyl-4′-methyldimethyl sulfide, 4-dimethylaminobenzoic acid, methyl 4-dimethylaminobenzoate, ethyl 4-dimethylaminobenzoate, butyl 4-dimethylaminobenzoate, 2-ethylhexyl ester of 4-dimethylaminobenzoic acid, 2-isoamyl ester of 4-dimethylaminobenzoic acid, acetophenone, 2,2-diethoxyacetophenone, p-dimethylacetophenone, p-dimethylaminopropiophenone, trichloroacetophenone, p-tert-butylacetophenone, benzyldimethyl ketal, benzyl-β-methoxyethyl acetal, 1-phenyl-1,2-propanedione-2-(o-ethoxycarbonyl)oxime, methyl o-benzoylbenzoate, bis(4-dimethylaminophenyl)ketone, 4,4′-bisdiethylaminobenzophenone, benzyl, benzoin, benzoin methyl ether, benzoin ethyl ether, benzoin isopropyl ether, benzoin n-butyl ether, benzoin isobutyl ether, benzoin butyl ether, p-dimethylaminoacetophenone, thioxanthone, 2-methylthioxanthone, 2-isopropylthioxanthone, dibenzosuberone, α,α-dichloro-4-phenoxyacetophenone, pentyl 4-dimethylaminobenzoate, triazine compounds such as 2,4-bis(trichloromethyl)-6-(3-bromo-4-methoxy)phenyl-s-triazine and 2,4-bis(trichloromethyl)-6-(p-methoxy)styryl-s-triazine, and the like.

In addition to the above, sulfur compounds such as thioxanthone, 2-chlorothioxanthone, 2,4-diethylthioxanthene, 2-methylthioxanthene and 2-isopropylthioxanthene; anthraquinones such as 2-ethylanthraquinone, octamethylanthraquinone, 1,2-benzanthraquinone and 2,3-diphenylanthraquinone; organic peroxides such as azobisisobutyronitrile, benzoyl peroxide and cumene peroxide; thiol compounds such as 2-mercaptobenzimidazole, 2-mercaptobenzoxazole, 2-mercaptobenzothiazole; and the like can be used.

A single kind or a combination of more than one kind of these photopolymerization initiators may be used. The quantity of this photopolymerization initiator is not particularly limited, but it is preferable that 0.1 to 30 parts by weight of the photopolymerization initiator be included based on 100 parts by weight of the polymeric silicon compound, and it is more preferable that 1 to 15 parts by weight of the photopolymerization initiator be included based on 100 parts by weight of the polymeric silicon compound. It is possible to improve the photocuring characteristics by including the photopolymerization initiator of the quantity of not less than the aforementioned lower limits. Moreover, by including the photopolymerization initiator of the quantity of not more than the aforementioned upper limits, smoothness in the formed pattern surface is likely to be excellent, therefore it is preferable.

Acid Generator and/or Alkali Generator

It is preferable to include an acid generator and/or an alkali generator in the film-forming composition of the present invention. The acid generator and/or the alkali generator preferably used in the present invention are/is not particularly limited, but can be appropriately selected from well known compounds depending on the composition and the like of the film-forming composition. Particularly, in the present invention, it is preferable to include a compound (a photoacid generator and/or a photoalkali generator) which generates acid and/or alkali in response to electromagnetic waves.

As this photoacid generator, it is possible to use well known acid generators such as e.g., an onium salt, a diazomethane derivative, a glyoxime derivative, a bissulfone derivative, a β-ketosulfone derivative, a disulfone derivative, a nitrobenzyl sulfonate derivative, a sulfonic acid ester derivative, and a sulfonic acid derivative of a N-hydroxyimide compound.

Examples of the onium salt include, specifically, tetramethylammonium trifluoromethanesulfonate, tetramethylammonium nonafluorobutanesulfonate, tetra-n-butylammonium nonafluorobutanesulfonate, tetraphenylammonium nonafluorobutanesulfonate, tetramethylammonium p-toluenesulfonate, diphenyliodonium trifluoromethanesulfonate, (p-tert-butoxyphenyl)phenyliodonium trifluoromethanesulfonate, diphenyliodonium p-toluenesulfonate, (p-tert-butoxyphenyl)phenyliodonium p-toluenesulfonate, triphenylsulfonium trifluoromethanesulfonate, (p-tert-butoxyphenyl)diphenylsulfonium trifluoromethanesulfonate, bis(p-tert-butoxyphenyl)phenylsulfonium trifluoromethanesulfonate, tris(p-tert-butoxyphenyl)sulfonium trifluoromethanesulfonate, triphenylsulfonium p-toluenesulfonate, (p-tert-butoxyphenyl)diphenylsulfonium p-toluenesulfonate, bis(p-tert-butoxyphenyl)phenylsulfonium p-toluenesulfonate, tris(p-tert-butoxyphenyl)sulfonium p-toluenesulfonate, triphenylsulfonium nonafluorobutanesulfonate, triphenylsulfonium butanesulfonate, trimethylsulfonium trifluoromethanesulfonate, trimethylsulfonium p-toluenesulfonate, cyclohexylmethyl(2-oxocyclohexyl)sulfonium trifluoromethanesulfonate, cyclohexylmethyl(2-oxocyclohexyl)sulfonium p-toluenesulfonate, dimethylphenylsulfonium trifluoromethanesulfonate, dimethylphenylsulfonium p-toluenesulfonate, dicyclohexylphenylsulfonium trifluoromethanesulfonate, dicyclohexylphenylsulfonium p-toluenesulfonate, trinaphthylsulfonium trifluoromethanesulfonate, cyclohexylmethyl(2-oxocyclohexyl)sulfonium trifluoromethanesulfonate, (2-norbonyl)methyl(2-oxocyclohexyl)sulfonium trifluoromethanesulfonate, ethylenebis [methyl(2-oxocyclopentyl)sulfonium trifluoromethanesulfonate], 1,2′-naphthylcarbonylmethyltetrahydrothiophenium triflate, and the like.

Examples of the diazomethane derivative include bis benzenesulfonyl)diazomethane, bis(p-toluenesulfonyl)diazomethane, bis(xylenesulfonyl)diazomethane, bis(cyclohexylsulfonyl)diazomethane, bis(cyclopentylsulfonyl)diazomethane, bis(n-butylsulfonyl)diazomethane, bis(isobutylsulfonyl)diazomethane, bis(sec-butylsulfonyl)diazomethane, bis(n-propylsulfonyl)diazomethane, bis(isopropylsulfonyl)diazomethane, bis(tert-butylsulfonyl)diazomethane, bis(n-amylsulfonyl)diazomethane, bis(isoamylsulfonyl)diazomethane, bis(sec-amylsulfonyl)diazomethane, bis(tert-amylsulfonyl)diazomethane, 1-cyclohexylsulfonyl-1-(tert-butylsulfonyl)diazomethane, 1-cyclohexylsulfonyl-1-(tert-amylsulfonyl)diazomethane, 1-tert-amylsulfonyl-1-(tert-butylsulfonyl)diazomethane, and the like.

Examples of the glyoxime derivative include bis-O-(p-toluenesulfonyl)-α-dimethylglyoxime, bis-O-(p-toluenesulfonyl)-α-diphenylglyoxime, bis-O-(p-toluenesulfonyl)-α-dicyclohexylglyoxime, bis-O-(p-toluenesulfonyl)-2,3-pentanedioneglyoxime, bis-O-(p-toluenesulfonyl)-2-methyl-3,4-pentanedioneglyoxime, bis-O-(n-butanesulfonyl)-α-dimethylglyoxime, bis-O-(n-butanesulfonyl)-α-diphenylglyoxime, bis-O-(n-butanesulfonyl)-α-dicyclohexylglyoxime, bis-O-(n-butanesulfonyl)-2,3-pentanedioneglyoxime, bis-O-(n-butanesulfonyl)-2-methyl-3,4-pentanedioneglyoxime, bis-O-(methanesulfonyl)-α-dimethylglyoxime, bis-O-(trifluoromethanesulfonyl)-α-dimethylglyoxime, bis-O-(1,1,1-trifluoroethanesulfonyl)-α-dimethylglyoxime, bis-O-(tert-butanesulfonyl)-α-dimethylglyoxime, bis-O-(perfluorooctanesulfonyl)-α-dimethylglyoxime, bis-O-(cyclohexanesulfonyl)-α-dimethylglyoxime, bis-O-(benzensulfonyl)-α-dimethylglyoxime, bis-O-(p-fluorobenzenesulfonyl)-α-dimethylglyoxime, bis-O-(p-tert-butylbenzenesulfonyl)-α-dimethylglyoxime, bis-O-(xylenesulfonyl)-α-dimethylglyoxime, bis-O-(camphorsulfonyl)-α-dimethylglyoxime, and the like.

Examples of the bissulfone derivative include bisnaphthylsulfonylmethane, bistrifluoromethylsulfonylmethane, bismethylsulfonylmethane, bisethylsulfonylmethane, bispropylsulfonylmethane, bisisopropylsulfonylmethane, bis-p-toluenesulfonylmethane, bisbenzensulfonylmethane, and the like.

Examples of the β-ketosulfone derivative include 2-cyclohexylcarbonyl-2-(p-toluenesulfonyl)propane, 2-isopropylcarbonyl-2-(p-toluenesulfonyl)propane, and the like.

Examples of the disulfone derivative include disulfone derivatives such as diphenyldisulfone derivatives and dicyclohexyldisulfone derivatives.

Examples of the nitrobenzyl sulfonate derivative include nitrobenzyl sulfonate derivatives such as 2,6-dinitrobenzyl p-toluenesulfonate and 2,4-dinitrobenzyl p-toluenesulfonate.

Examples of the sulfonic acid ester derivative include sulfonic acid ester derivatives such as 1,2,3-tris(methanesulfonyloxy)benzene, 1,2,3-tris(trifluoromethanesulfonyloxy)benzene, and 1,2,3-tris(p-toluenesulfonyloxy)benzene.

Examples of the sulfonic acid ester derivative of the N-hydroxyimide compound include N-hydroxysuccinimide methanesulfonate, N-hydroxysuccinimide trifluoromethanesulfonate, N-hydroxysuccinimide ethanesulfonate, N-hydroxysuccinimide 1-propanesulfonate, N-hydroxysuccinimide 2-propanesulfonate, N-hydroxysuccinimide 1-pentanesulfonate, N-hydroxysuccinimide 1-octanesulfonate, N-hydroxysuccinimide p-toluenesulfonate, N-hydroxysuccinimide p-methoxybenzenesulfonate, N-hydroxysuccinimide 2-chloroethanesulfonate, N-hydroxysuccinimide benzenesulfonate, N-hydroxysuccinimide 2,4,6-trimethylbenzenesulfonate, N-hydroxysuccinimide 1-naphthalenesulfonate, N-hydroxysuccinimide 2-naphthalenesulfonate, N-hydroxy-2-phenylsuccinimide methanesulfonate, N-hydroxymaleimide methanesulfonate, N-hydroxymaleimide ethanesulfonate, N-hydroxy-2-phenylmaleimide methanesulfonate, N-hydroxyglutarimide methanesulfonate, N-hydroxyglutarimide benzenesulfonate, N-hydroxyphthalimide methanesulfonate, N-hydroxyphthalimide benzenesulfonate, N-hydroxyphthalimide trifluoromethanesulfonate, N-hydroxyphthalimide p-toluenesulfonate, N-hydroxynaphthalimide methanesulfonate, N-hydroxynaphthalimide benzenesulfonate, N-hydroxy-5-norbornene-2,3-dicarboximide methanesulfonate, N-hydroxy-5-norbornene-2,3-dicarboximide trifluoromethanesulfonate, N-hydroxy-5-norbornene-2,3-dicarboximide p-toluenesulfonate, and the like.

Moreover, examples of the photoalkali generator include optically active carbamate such as triphenylmethanol, benzyl carbamate, and benzoin carbamate; amides such as O-carbamoylhydroxylamide, O-carbamoyl oxime, aromatic sulfonamide, alpha-lactam, and N-(2-allylethynyl)amide, as well as other amides; oxime esters, α-aminoacetophenone, cobalt complexes, and the like. Among these, preferable examples include 2-nitrobenzylcyclohexyl carbamate, triphenylmethanol, o-carbamoylhydroxylamide, o-carbamoyl oxime, [[(2,6-dinitrobenzyl)oxy]carbonyl]cyclohexylamine, bis[[(2-nitrobenzyl)oxy-]carbonyl]hexane 1,6-diamine, 4-(methylthiobenzoyl)-1-methyl-1-morpholinoethane, (4-morpholinobenzoyl)-1-benzyl-1-dimethylaminopropane, N-(2-nitrobenzyloxycarbonyl)pyrrolidine, hexaamminecobalt (III) tris(triphenylmethyl. borate), 2-benzyl-2-dimethylamino-1-(4-morpholinophenyl)-butanone, and the like.

A single kind or a combination of more than one kind of the photopolymerization initiators may be used.

The quantity of the acid generator and/or the alkali generator is not particularly limited, but it is preferable that 0.1 to 30 parts by weight of the acid generator and/or the alkali generator be included based on 100 parts by weight of the polymeric silicon compound, and it is more preferable that 1 to 15 parts by weight of the acid generator and/or the alkali generator be included based on 100 parts by weight of the polymeric silicon compound. It is possible to improve the photocuring characteristics by including the acid generator and/or the alkali generator of the quantity of not less than the aforementioned lower limits. Moreover, by including the acid generator and/or the alkali generator of the quantity of not more than the aforementioned upper limits, smoothness in the formed pattern surface is likely to be excellent, therefore it is preferable.

### Surfactant

It is preferable to include a surfactant in the film-forming composition of the present invention. It is possible to improve application properties and spreading properties to the substrate by the presence of the surfactant.

### Solvent

It is preferable that the film-forming composition of the present invention includes a solvent, for the purpose of improving application properties and film thickness uniformity. Conventionally used organic solvents can be used as this solvent. Specific examples include monohydric alcohols such as methyl alcohol, ethyl alcohol, propyl alcohol, butyl alcohol, 3-methoxy-3-methyl-1-butanol, and 3-methoxy-1-butanol; alkyl carboxylate such as methyl-3-methoxypropionate and ethyl-3-ethoxypropionate; polyhydric alcohols such as ethylene glycol, diethylene glycol, and propylene glycol; polyhydric alcohol derivatives such as ethylene glycol monomethyl ether, ethylene glycol monoethyl ether, ethylene glycol monopropyl ether, ethylene glycol monobutyl ether, propylene glycol monomethyl ether, propylene glycol monoethyl ether, propylene glycol monopropyl ether, propylene glycol monobutyl ether, ethylene glycol monomethyl ether acetate, ethylene glycol monoethyl ether acetate, propylene glycol monomethyl ether acetate, and propylene glycol monoethyl ether acetate; fatty acids such as acetic acid and propionic acid; and ketones such as acetone, methyl ethyl ketone, and 2-heptanone. These organic solvents may be used alone, or more than of them may be used in combination.

The quantity of this solvent is not particularly limited, but the concentration of the components (solid content) excluding the solvent, such as the polymeric silicon compound, the photopolymerization initiator, the acid generator and/or the alkali generator, is preferably in a range of 5 to 100% by mass, and more preferably in a range of 20 to 50% by mass. It is possible to improve application properties by setting these ranges.

### Others

Moreover, in the present invention, it is possible to include other resins, additives and the like in the range not to impair the effects of the invention. It is possible to appropriately select the other formulation ingredients depending on the function desirable to be provided to the resist.

### EXAMPLES

Next, the present invention will be explained in more detail with reference to Examples; however, the present invention should not be construed as being limited thereto.

### Example 1

1 mol of tetraethoxysilane, 0.5 mol of monoacryloxypropyltrimethoxysilane, and 0.5 mol of monovinyltrimethoxysilane were dissolved in 170 g of isopropyl alcohol. Subsequently, 190 g of pure water and 0.02 g of concentrated nitric acid were added thereto, and the mixture was stirred at the room temperature for six hours. The obtained composition was diluted with isopropyl alcohol so that the solid content in terms of SiO₂ became 7%. Subsequently, to 100 g of the obtained liquid, 1 g of IRGACURE-369 (produced by Ciba Specialty Chemicals: 2-benzyl-2-dimethylamino-1-(4-morpholinophenyl)-butan-1-one) was added as a photopolymerization initiator, thereby preparing an application liquid.

### Comparative Example 1

29.5 g of methyltrimethoxysilane, 33.0 g of tetramethoxysilane, and 83.0 g of a mixed solvent of acetone:isopropyl alcohol=2:1 were mixed and stirred. Thereto were added 54.6 g of water and 4.7 μL of 60% nitric acid, and the mixture was further stirred for three hours. Thereafter, the mixture was aged at 26° C. for two days. The obtained composition was diluted with a mixed solvent of acetone:isopropyl alcohol=2:1 so that the solid content in terms of SiO₂ became 7%, thereby obtaining an application liquid.

### Ultraviolet Irradiation

The application liquids respectively obtained in Example 1 and Comparative Example 1 were applied to silicon wafers by using a spinner at 2,000 rpm, and were dried. Subsequently, ultra-violet rays were irradiated by using, as a ultra-violet light source, a UV device manufactured by Japan Storage Battery Co., LTD. The application liquid obtained in Example 1 was photocured, while the application liquid obtained in Comparative Example 1 was not.

### INDUSTRIAL APPLICABILITY

The nanostructure provided by the present invention serves as a structure having microstructures of not more than several nanometers, depending on the precision of the mold to be used. Therefore, the nanostructure is preferably used in the field which requires hyperfine structures such as optical elements (e.g., semiconductor devices, wiring substrates, diffraction gratings, and a polarizing elements) or analysis devices (e.g., capillary columns).

1. A film-forming composition for nanoimprinting comprising a polymeric silicon compound having a function to produce a photocuring reaction.

2. The film-forming composition according to claim 1, wherein the polymeric silicon compound has a functional group that is cleavable in response to electromagnetic waves, and produces a curing reaction by electromagnetic radiation.

3. The film-forming composition according to claim 1, wherein the polymeric silicon compound is at least one selected from a group consisting of a siloxane polymer compound, a silicon carbide polymer compound, a polysilane polymer compound, and a silazane polymer compound.

4. The film-forming composition according to claim 1, wherein a weight-average molecular weight of the polymeric silicon compound is from 1,000 to 50,000.

5. The film-forming composition according to claim 1, wherein the polymeric silicon compound is a condensation polymerization product of a compound including, as a starting material, at least one selected from alkoxysilanes represented by the following formula (A):
R¹ₙ—Si(OR²)₄₋ₙ (A)
wherein R¹ is a hydrogen atom, or an alkyl group or an aryl group having 1 to 20 carbon atoms; at least one of R¹ has a functional group that is cleavable in response to electromagnetic waves; R² is an alkyl group having 1 to 5 carbon atoms; and n represents an integer of 1 to 3.

6. The film-forming composition according to claim 2, wherein the functional group that is cleavable in response to electromagnetic waves is at least one selected from a group consisting of an epoxy group, an acryl group, a methacryl group, and an oxetanyl group.

7. The film-forming composition according to claim 2, wherein the electromagnetic waves are ultra-violet rays, or light rays or corpuscular rays with a wavelength being shorter than the ultra-violet rays.

8. The film-forming composition according to claim 2, further comprising a hydrocarbon-based resin that is responsive to the electromagnetic waves.

9. The film-forming composition according to claim 1, further comprising a photopolymerization initiator.

10. The film-forming composition according to claim 1, further comprising an acid generator and/or an alkali generator.

11. The film-forming composition according to claim 1, further comprising a surfactant.

12. A photosensitive resist for use in nanoimprint lithography, the photosensitive resist being obtained by curing the film-forming composition according to claim 1.

13. A method for pattern formation by nanoimprint lithography,
the method comprising.
a lamination process in which the film-forming composition according to claim 1 is laminated to a substrate, thereby forming a film-forming composition layer;
a transformation process in which a mold, on which a pattern of a relief structure is formed, is pressed against the film-forming composition layer on the substrate, thereby transforming the film-forming composition layer into the pattern of the relief structure; and
a transfer process in which electromagnetic waves are irradiated to the film-forming composition layer to form a resist, in a state where the mold is in contact with the film-forming composition layer, thereby transferring the pattern of the relief structure to the resist.

14. The method for pattern formation according to claim 13, wherein the transfer process is performed under reduced pressure or in a vacuum.

15. The method for pattern formation according to claim 13, further comprising a baking process of baking the resist on which the pattern of the relief structure has been transferred.

16. The method for pattern formation according to claim 13, further comprising, after the transfer process: a release process in which the mold is released from the resist; and an etching process in which at least a portion of the resist is removed by irradiation of a plasma and/or reactive ion.

17. The method for pattern formation according to claim 16, wherein, in the etching process, the etching is performed to the substrate simultaneously or sequentially with at least a portion of the resist.

18. A nanostructure obtained by the method for pattern formation according to claim 13.

19. The nanostructure according to claim 18, wherein the nanostructure is selected from the group consisting of a semiconductor device, a wiring substrate, an optical element, and an analysis device.

20. A program for allowing a computer to execute pattern formation by nanoimprint lithography,
the pattern formation comprising:
a compression step in which a mold, on which a pattern of a relief structure has been formed, is pressed against a film-forming composition layer formed by laminating the film-forming composition according to claim 1 on a substrate, so as to compress the film-forming composition layer to give a desired shape;
a transfer step in which electromagnetic waves are irradiated to the film-forming composition layer to form a resist, in a state where the mold is in contact with the film-forming composition layer, thereby transferring the pattern of the relief structure to the resist; and
a release step in which the mold is released from the resist, wherein the compression step further comprises a step of controlling a load, and
wherein the transfer step further comprises a step of controlling a load, a temperature, and time.
